(19) United States
(12) Patent Application Publication
(10) Pub. No.: US 2019/0274065 A1
(43) Pub. Date: Sep. 5, 2019

(54) METHOD AND APPARATUS FOR CONGESTION CONTROL IN WIRELESS COMMUNICATION

(71) Applicant: Samsung Electronics Co., Ltd., Gyeonggi-do (KR)

(72) Inventors: Yi ZHAO, Beijing (CN); Shichang ZHANG, Beijing (CN); Lixiang XU, Beijing (CN); Weina LI, Beijing (CN); Yuhan HU, Beijing (CN); Chunling ZHANG, Beijing (CN)

(21) Appl. No.: 16/347,014

(22) PCT Filed: Oct. 31, 2017
(86) PCT No.: PCT/KR2017/012123

§ 371 Date: May 2, 2019

(30) Foreign Application Priority Data
Nov. 4, 2016 (CN) 201610974595.X
Jan. 11, 2017 (CN) 201710018270.9

(51) Int. Cl. H04W 28/02; H04W 4/40; H04W 24/10; H04W 76/27

(52) U.S. Cl. CPC H04W 28/0289; H04W 76/27; H04W 24/10; H04W 4/40

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. Disclosed are a method and an apparatus for a congestion control in wireless communication, the method includes: a network side node receives a congestion related information reported by a UE or UEs, determines a congestion control range or congestion control ranges based on the congestion related information reported by the UE or UEs and transmits determined congestion control range information to a UE or UEs; the UE or UEs receives the congestion control range information transmitted by the network side node, determines whether the UE or UEs is/are within the congestion control range according to the received congestion control range information, and performs the congestion control when the UE or UEs is/are within the congestion control range. The congestion related information is reported to the network side through the UE or UEs such that the network side can more accurately grasp the global congestion situation, thus facilitating the formulation of more optimized congestion control strategy and meanwhile reducing information exchange between the UEs, reducing the resource consumption of the PC5 interface, and reducing the possibility of the occurrence of the congestion.

### TECHNICAL FIELD

The present disclosure relates to the field of wireless communication, more particularly, to a method and an apparatus for congestion control in wireless communication.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Congestion control in wireless communication is a very important part of V2X (vehicle to everything). V2X technology enables a vehicle to obtain a series of traffic information including real-time surrounding vehicles, road and pedestrian status etc. through the communication between a car and a car, a car and a road (including base station and roadside infrastructure), a car and people, thereby enhancing driving safety, reducing congestion, improving traffic efficiency, etc., which is the key technology of the future intelligent traffic and automatic driving.

Many countries have put into research for the key technology of V2X and are actively promoting standardizations. The Institute of Electrical and Electronics Engineers (IEEE) and the European Telecommunications Standards Institute (ETSI) take the lead in making wireless access standards for the automotive environment of the United States and Europe. The United States has made a series of standards for WAVE (802.11p+1609+J2735), and ETSI has made a series of standards for TC-ITS (physical layer and part of the MAC use 802.11). It should be noted that both WAVE and ETSI TC-ITS uses a self-organizing V2X communication mode. In order to be competitive in the field of V2X car networking, 3GPP started the V2X-oriented standardization work based on LTE technology in 2014. Currently, two scenarios are discussed currently: 1) V2X of directly communicating based on PC5 interface (base station may (auxiliarily) perform operations such as resource allocation etc.) 2) V2X of forwarding based on Uu interface (i.e. V2X communication between vehicles and other entities needs to be forwarded through the base station).

In order to provide road safety service based on the V2X communication, the current mainstream viewpoint is that the basic transmission period of the vehicle road safety information is 100 ms (WAVE system and LTE-V2X), but since the spectrum resources allocated for V2X are limited (currently allocated bandwidth for road safety service is 10 MHz), when the V2X node density increases, the performance of V2X communication will be significantly reduced. In order to ensure the performance of the V2X communication at high node density, it is necessary to adopt a congestion control mechanism. WAVE system and ETSI TC-ITS have designed the corresponding congestion control methods: LIMERIC (for WAVE), DCC (Distributed congestion control) (for ETSI ITS). V2X nodes interact the congestion related information perceived by themselves in self-organizing direct communication mode so that vehicles can obtain congestion situation information within a certain range. When a congestion state reaches a set condition, the congestion is controlled by reducing the transmission power and the transmission rate.

LTE system also has congestion control mechanism, which is used to control the congestion generated by a Uu interface resource and a network resource in the entire cell. The congestion control mode for resources in the existing LTE system is that when the network determines that a congestion occurs in the Uu resource, it is forced that the UE without satisfying the AC condition in the cell cannot initiate the access through the AC barring (Access Class Barring) mode, thus reducing the network congestion.

### DISCLOSURE OF INVENTION

### Technical Problem

In self-organizing congestion control, there are two types of congestion control mode: a congestion control mode in which there is no congestion information interaction between vehicles, and a congestion control mode based on the congestion information interaction between vehicles. The two current modes exist the following problems:

The congestion control mode in which there is no congestion information interaction between vehicles: this mode cannot solve the congestion control problem well because it can not perceive the global congestion situation.

The congestion control mode based on the congestion information interaction between vehicles: this mode may introduce a larger air interface overhead (especially if a multiple-hop information forwarding is needed), and furthermore may cause the congestion state to come earlier.

In addition, if the congestion control of V2X is customized in a cell as a unit, there are the following problems:

It is assumed that there are both a high congestion area and a low congestion area in one cell, if the base station formulates a congestion control strategy based on the high congestion area, it would not be able to guarantee the communication requirement of the road safety service in the low congestion area (for high congestion, the transmission rate and transmission power are generally reduced), and if the base station formulates a congestion control strategy based on the low congestion area, it will not be able to guarantee the communication requirements of the road safety service in the high congestion area (the interference increasing causes that the road safety related information cannot to be sent within the required range). The typical scenarios are like: 1) a congestion has occurred at one end of a road crossing a cell while no congestion has occurred at the other end; 2) on a road with a tidal effect, a serious congestion has occurred in one driving direction while there are a small number of vehicles in another driving direction.

### Solution to Problem

The present disclosure provides a method and an apparatus for V2X congestion control with the participation of a network based on the features of V2X congestion, the method may determine a congestion control range or congestion control ranges through a network side according to congestion related information reported by a UE or UEs, and transmits congestion control range information, congestion control information and/or a congestion control strategy or congestion control strategies corresponding to the a congestion control range or congestion control ranges to a UE or UEs. After the UE receives the congestion control range information transmitted by the network side, the UE determines whether the UE is within the corresponding congestion control range. When it is determined that the UE is within one or more congestion control range, the corresponding congestion control is performed. Thus, the network may more accurately grasp the global congestion situation based on the reporting of data by the UE, determine more accurate areas for which the congestion control is required, formulate more optimized congestion control strategy; meanwhile, information exchange between the UEs may be reduced, the resource consumption of the PC5 interface may be reduced, and the possibility of the occurrence of the congestion may be reduced.

According to one aspect of the present disclosure, a congestion control method for a network side node is provided, the congestion control method includes: receiving congestion related information reported by a UE or UEs; determining a one congestion control range or one congestion control ranges based on the congestion related information reported by the a UE or UEs; transmitting at least one of following items to a UE or UEs: determined congestion control range information; congestion control information and/or a congestion control strategy or congestion control strategies corresponding to the a congestion control range or congestion control ranges.

The congestion control information may include at least one of: congestion level information, transmission rate optional range information, transmission power optional range information, priority information of service/data permitted to be transmitted, available resource pool information, data transmission mode information that is permitted or prohibited, multi-hop transmission configuration information.

The congestion control strategy may include at least one of adjusting transmission rate, adjusting a transmission power, adjusting a transmitted service, adjusting a size of transmitted data packet, adjusting the number of occupied resources, adjusting a used resource pool, adjusting a data transmission mode, adjusting a multi-hop transmission configuration of data transmission.

According to another aspect of the present disclosure, a congestion control method for a user equipment UE is provided, the congestion control method may include: receiving at least one of following items transmitted by the network side node: congestion control range information; congestion control information and/or a congestion control strategy or congestion control strategies corresponding to the a congestion control range or congestion control ranges, wherein in a case that the congestion control range information is received, determining whether the UE is within the congestion control range based on the received congestion control range information and performing congestion control when the UE is within the congestion control range, and wherein in a case that only the congestion control information and/or the congestion control strategy or congestion control strategies are received, directly performing the congestion control.

In the case where it is determined that the UE is within the congestion control range, the performing of the congestion control may include: performing the congestion control based on the congestion control range; or performing the congestion control based on the congestion control range, and the congestion control information and/or the a congestion control strategy or congestion control strategies corresponding to the a congestion control range or congestion control ranges.

The performing of the congestion control based on the congestion control information corresponding to the congestion control range or congestion control ranges may include: according to at least one of the received congestion control information, the UE adjusts at least one of the transmission power, the transmission rate, the transmitted service, the size of the transmitted data packet, the number of occupied resources, the used resource pool, the available data transmission mode, the multi-hop transmission configuration of the data transmission according to the set congestion control algorithm.

The performing of the congestion control based on the congestion control strategy or congestion control strategies corresponding to the congestion control range or congestion control ranges may include: according to at least one of the received congestion control strategy, the UE adjusts at least one of the transmission power, the transmission rate, the transmitted service, the size of the transmitted data packet, the number of occupied resources, the used resource pool, the available data transmission mode, the multi-hop transmission configuration of the data transmission according to the set congestion control algorithm.

The performing of the congestion control based on the congestion control information and the congestion control strategy or congestion control strategies may include: according to the received congestion control information and congestion control strategy or congestion control strategies, the UE jointly determines at least one of the transmission power, the transmission rate, the transmitted service, the size of transmitted data packet, the number of occupied resources, the used resource pool, the available data transmission mode, the multi-hop transmission configuration of the data transmission according to the set congestion control algorithm.

According to one aspect of the present disclosure, an apparatus for congestion control is provided, the apparatus may include: a receiving module to receive congestion related information reported by a user equipment UE or UEs; a determining module to determine the congestion control range or congestion control ranges based on the congestion related information reported by a UE or UEs; a transmitting module to transmit at least one of following items to a UE or UEs: determined congestion control range information; congestion control information and/or a congestion control strategy or congestion control strategies corresponding to the a congestion control range or congestion control ranges.

The congestion related information reported by the UE or UEs may include at least one of geographic location information of the UE or UEs, channel/resource occupation status information, RSSI measurement information, transmission power information of the UE or UEs, transmission rate information of the UE or UEs, transmission service information of the UE or UEs, information about the number of resources occupied by the UE or UEs, transmission service priority information of the UE or UEs, type information of a node or nodes corresponding to the UE or UEs, attribute information of the node or nodes corresponding to the UE or UEs, motion state information of the UE or UEs, road environment information perceived by the UE or UEs, and success rate information of the UE or UEs receiving a data packet transmitted by a surrounding node or surrounding nodes.

The determining module may select a physical variable or physical variables for defining a congestion control range, and determine a congestion control range or congestion control ranges based on at least one information included in the congestion related information reported by the UE or UEs according to the selected physical variable or physical variables for defining the congestion control range, wherein the physical variable or physical variables for defining the congestion control range may be selected in real time by the network side node or may be selected in accordance with a convention between the network side node and the UE, or may be indicated by a protocol specification or may be indicated by a high layer signalling, or may be configured by a high layer entity.

The physical variable or physical variables for defining the congestion control range may include at least one of a geographic area, a resource pool, a power range, a transmission rate range, a priority of a transmitted service/data, a data transmission mode that is used or prohibited, a multi-hop transmission configuration, a node type and a node attribute.

In a case that the selected physical variable for defining the congestion control range is the geographical area, the determining module may determine the congestion control range based on geographic location information of the UE or UEs reported by the UE or UEs or determine the geographical area for which a congestion control is required based on the geographical location information and channel/resource occupation status information reported by the UE or UEs, wherein the congestion control range is defined by the geographical area;

In a case that the selected physical variable for defining the congestion control range is the resource pool, the determining module may determine the congestion control range based on the channel/resource occupation status information reported by the UE or UEs, wherein the congestion control range is defined by the resource pool;

In a case that the selected physical variables for defining the congestion control range are both the geographical area and the resource pool, the determining module may determine a congestion control range or congestion control ranges based on the geographic location information of the UE or UEs and the channel/resource occupation status information reported by the UE or UEs, wherein the congestion control range or congestion control ranges is/are defined collectively by both the geographical area and the resource pool.

The determining module determining a congestion control range or congestion control ranges based on the geographic location information of the UE or UEs reported by the UE or UEs may include: determining distribution density of UEs based on geographical location information of the UE or UEs reported by the UE or UEs, and determining the geographical area for which a congestion control is required based on the distribution density of the UEs.

The determining module determining a congestion control range or congestion control ranges based on the geographical location information and the channel/resource occupation status information reported by the UE or UEs may include: based on the geographical location information of the UE or UEs and the channel/resource occupation status information in the corresponding resource pool used by the UE or UEs, reported by the UE or UEs, determining the geographical area for which a congestion control is required through setting the geographic area in which channel/resource occupation status information are similar into one congestion control range.

The determining module determining a congestion control range or congestion control ranges based on the channel/resource occupation status information reported by the UE or UEs may include: determining the resource pool for which a congestion control is required based on the channel/resource occupation status information reported by the UE or UEs in the corresponding resource pool used by the UE or UEs.

The determining module determining a congestion control range or congestion control ranges based on the geographic location information of the UE or UEs and the channel/resource occupation status information reported by the UE or UEs may include: determining a resource occupation status in the resource pool of the geographical area based on the geographic location information of the UE or UEs and the channel/resource occupation status information in the corresponding resource pool used by the UE or UEs, reported by the UE or UEs, and determining the congestion control range or congestion control ranges according to the resource occupation status.

The congestion control information may include at least one of the congestion level information, the transmission rate optional range information, the transmission power optional range information, the priority information of service/data permitted to be transmitted, the available resource pool information, the data transmission mode information that is permitted or prohibited, the multi-hop transmission configuration information.

The congestion control strategy may include at least one of adjusting the transmission rate, adjusting the transmission power, adjusting the transmitted service, adjusting the size of transmitted data packet, adjusting the number of occupied resources, adjusting the used resource pool, adjusting the data transmission mode, adjusting the multi-hop transmission configuration of the data transmission.

According to another aspect of the present disclosure, an apparatus for congestion control is provided, the apparatus may include: a receiving module to receive at least one of congestion control range information and congestion control information and/or a congestion control strategy or congestion control strategies corresponding to a congestion control range or congestion control ranges; a determining module to determine whether the apparatus is within the congestion control range based on the received congestion control range information; an executing module to execute the congestion control when determining that the apparatus is within the congestion control range, wherein in a case that only the congestion control information and/or the congestion control strategy are received, the executing module directly executes the congestion control.

The congestion control range information may include at least one of congestion control range information defined by using a geographical area, congestion control range information defined by using a resource pool, congestion control range information defined by using a power range, congestion control range information defined by using a transmission rate range, congestion control range information defined by using a priority of transmitted service/data, congestion control range information defined by using a data transmission mode that is used or prohibited, congestion control range information defined by using a multi-hop transmission configuration, congestion control range information defined by using a node type, and congestion control range information defined by using a node attribute.

The congestion control information may include at least one of the congestion level information, the transmission rate optional range information, the transmission power optional range information, the priority information of service/data permitted to be transmitted, the available resource pool information, the data transmission mode information that is permitted or prohibited, the multi-hop transmission configuration information.

The congestion control strategy may include at least one of adjusting the transmission rate, adjusting the transmission power, adjusting the transmitted service, adjusting the size of transmitted data packet, adjusting the number of occupied resources, adjusting the used resource pool, adjusting the data transmission mode, adjusting the multi-hop transmission configuration of the data transmission.

In a case of determining that the user equipment is within the congestion control range, the executing module may execute the congestion control based on the congestion control range or base on the congestion control range, the congestion control information and/or a congestion control strategy or congestion control strategies corresponding to the a congestion control range or congestion control ranges.

In a case that the executing module executes the congestion control based on the congestion control information corresponding to the congestion control range, according to at least one of the received congestion control information, the executing module may adjust at least one of the transmission power, the transmission rate, the transmitted service, the size of transmitted data packet, the number of occupied resources, the used resource pool, the available data transmission mode, the multi-hop transmission configuration of the data transmission according to the set congestion control algorithm.

In a case that the executing module executes the congestion control based on a congestion control strategy or congestion control strategies corresponding to the a congestion control range or congestion control ranges, according to at least one of the received congestion control strategy, the executing module may adjust at least one of the transmission power, the transmission rate, the transmitted service, the size of transmitted data packet, the number of occupied resources, the used resource pool, the available data transmission mode, the multi-hop transmission configuration of the data transmission according to the set congestion control algorithm.

In a case that the executing module executes congestion control based on the congestion control strategy or congestion control strategies and the congestion control information, according to the received congestion control strategy or congestion control strategies and the congestion control information, the executing module can jointly determine at least one of the transmission power, the transmission rate, the transmitted service, the size of transmitted data packet, the number of occupied resources, the used resource pool, the available data transmission mode, the multi-hop transmission configuration of the data transmission according to the set congestion control algorithm.

According to one aspect of the present disclosure, a congestion control system is provided, the system may include: a network side node to receive congestion related information reported by a UE or UEs, determine a congestion control range or congestion control ranges based on the congestion related information reported by a UE or UEs; transmit at least one of following items to a UE or UEs: determined congestion control range information, congestion control information and/or a congestion control strategy or congestion control strategies corresponding to a congestion control range or congestion control ranges; a UE or UEs to receive at least one of following items transmitted by the network side node: the congestion control range information, the congestion control information and/or a congestion control strategy or congestion control strategies corresponding to a congestion control range or congestion control ranges, determine whether the UE or UEs is/are within the congestion control range or congestion control ranges based on the received congestion control range information, and perform the congestion control when the UE or UEs is/are within the congestion control range or congestion control ranges, wherein in a case that only the congestion control information and/or the congestion control strategy or congestion control strategies are received by the UE or UEs, directly performing the congestion control.

According to another aspect of the present disclosure, a congestion control method is provided, the congestion control method may include: a network side node receives congestion related information reported by a UE or UEs, determines a congestion control range or congestion control ranges based on the congestion related information reported by a UE or UEs, and transmits at least one of following items to the a UE or UEs: determined congestion control range information, congestion control information and/or a congestion control strategy or congestion control strategies corresponding to a congestion control range or congestion control ranges; the UE receives at least one of following items transmitted by the network side node: the congestion control range information, the congestion control information and/or a congestion control strategy or congestion control strategies corresponding to the a congestion control range or congestion control ranges, determines whether the UE is within the congestion control range based on the received congestion control range information, and performs the congestion control when the UE is within the congestion control range, wherein in a case that only the congestion control information and/or the congestion control strategy or congestion control strategies are received by the UE, the UE directly performs the congestion control.

### Advantageous Effects of Invention

According to one aspect of the present disclosure, the congestion related information is reported to the network side through the UE or UEs such that the network side can more accurately grasp the global congestion situation, thus facilitating the formulation of more optimized congestion control strategy and meanwhile reducing information exchange between the UEs, reducing the resource consumption of the PC5 interface, and reducing the possibility of the occurrence of the congestion.

### BRIEF DESCRIPTION OF DRAWINGS

FIG. 1 is a block diagram which illustrates the configuration of a system for congestion control according to an exemplary embodiment;

FIG. 2 is a schematic diagram which illustrates a method for congestion control according to an exemplary embodiment;

FIG. 3 is a flowchart which illustrates a congestion control method for a network side node according to an exemplary embodiment of the present disclosure;

FIG. 4 is a block diagram which illustrates the configuration of an apparatus for congestion control according to an exemplary embodiment;

FIG. 5 is a flowchart which illustrates a congestion control method for a user equipment (UE) according to an exemplary embodiment of the present disclosure;

FIG. 6 is a block diagram which illustrates the configuration of an apparatus for congestion control according to an exemplary embodiment;

FIG. 7 is a schematic diagram which illustrates a single-layer index mode for locating a geographic area for which a congestion control is required according to an exemplary embodiment;

FIG. 8 is a schematic diagram which illustrates a multi-layer index mode for locating a geographic area for which a congestion control is required according to an exemplary embodiment;

FIG. 9A and FIG. 9B are schematic diagrams which illustrate a relative index mode for locating a geographic area for which a congestion control is required according to an exemplary embodiment.

### MODE FOR THE INVENTION

Exemplary embodiments of the present disclosure will now be described in detail, the examples of which are illustrated in the accompanying drawings, wherein like reference numerals refer to like parts. Hereinafter, the embodiments will be described with reference to the accompanying drawings so as to explain the present disclosure.

It should be understood that the term “congestion control” used in the present disclosure may also be described with other names, such as “transmission behavior control”.

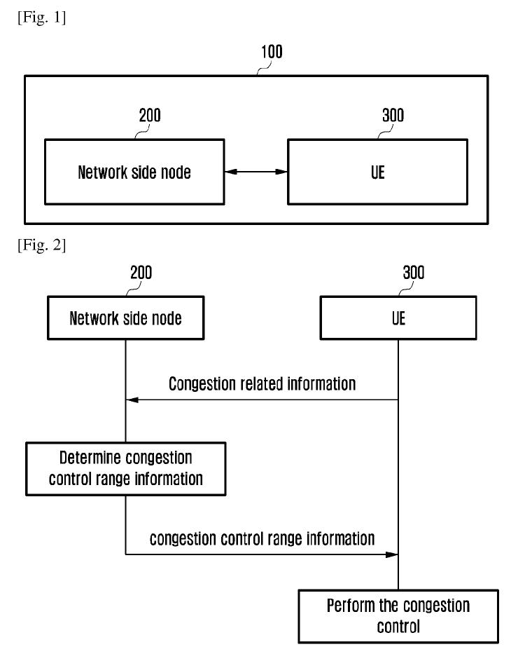

FIG. 1 is a block diagram which illustrates the configuration of a system for congestion control according to an exemplary embodiment of the present disclosure. As shown in FIG. 1, the system 100 for congestion control according to an exemplary embodiment includes a network side node 200 and a user equipment (UE) 300. In the present disclosure, the network side node 200 may be an existing network side node such as an eNB or a relay, etc., or may be a new network side node that may appear in the future, and may be a special type of network side node such as an RSU. The UE 300 may be either an onboard UE or a handheld UE (e.g., a mobile phone), or may also be a special UE placed in a scene such as the roadside, etc.

FIG. 2 is a schematic diagram which illustrates a method for congestion control according to an exemplary embodiment. Referring to FIG. 2, at first, the UE 300 reports congestion related information obtained by itself to the network side node, wherein the congestion related information may be the information related to the transmission behavior of the UE, and in particular, the congestion related information reported by the UE may include at least one of geographic location information of the UE, channel/resource occupation status information, receiving signal strength indication (RSSI)measurement information (e.g., S-RSSI), transmission power information of the UE, transmission rate information of the UE, transmission service information of the UE, information about the number of resources (the average number of resources or the maximum number of resources) occupied by the UE, transmission service priority information of the UE, type (e.g., ordinary vehicle or special vehicle) information of a node corresponding to the UE, attribute (e.g., the size of the vehicle node, etc.) information of the node corresponding to the UE, motion state (e.g. speed, direction, acceleration, etc.) information of the UE, road environment information perceived by the UE (e.g., whether it is a wet and slippery road, etc.), and success rate information of the UE receiving a data packet or data packets transmitted by a surrounding node or surrounding nodes. However, the present disclosure is not limited thereto.

In particular, the UE may obtain the congestion related information in the following manners: 1, obtaining the congestion related information through sensors associated with the UE, for example, obtaining geographic location information of the UE or UEs through a GNSS (Global Navigation Satellite System), obtaining direction information through the gyroscope, obtaining speed/temperature information through a speed/temperature sensor, perceiving road environment information through a camera and so on; 2, obtaining after receiving information transmitted by other nodes to the UE and calculating these information, for example, a success rate of the UE receiving a data packet or data packets transmitted by a surrounding node or surrounding nodes and so on; 3, receiving a notification message of other apparatus to the UE, for example, the road environment information (including the road environment, weather environment, driving environment (such as whether there are fault vehicles, etc.) transmitted by other nodes; 4, obtaining through the UE's own measurement, such as RSSI, etc.; 5, obtaining through the UE's own attribute information, such as the transmission power of the UE, the transmission rate of the UE, the transmission service/data information (including the priority information) of the UE, the number of resources occupied by the UE, the node type, the node attribute, etc.; 6, obtaining through the external input, such as the node type, etc.; 7, obtaining by calculation/statistics/analysis, such as the average/maximum/minimum number of the resources occupied by the UE, the average transmission power/transmission rate of the UE and so on. Herein, after the UE obtains the congestion related information, the UE 300 may report the congestion related information to the network based on a predetermined rule. For example, the UE 300 may periodically report the congestion related information to the network according to a predetermined period or report the congestion related information to the network side according to the event trigger.

Next, the network side node 200 receives the congestion related information reported by the UE 300 and determines the congestion control range based on the congestion related information reported by the UE after receiving the congestion related information (it should be noted that in the determining of a congestion control range or congestion control ranges, the determining of a congestion control range or congestion control ranges based on the congestion related information reported by the UE in the present disclosure does not limit that the network side can determine a congestion control range or congestion control ranges by only using the congestion related information reported by the UE or UEs, for example, the network side may use the information obtained by other means (e.g., a server provides) and the congestion related information reported by the UE or UEs to collectively determine the congestion control range) and transmits the determined congestion control range information to a UE or UEs. Herein, the congestion control range information may include at least one of congestion control range information defined by using the geographical area, congestion control range information defined by using a resource pool, congestion control range information defined by using a power range, congestion control range information defined by using a transmission rate range, congestion control range information defined by using a priority of transmitted service/data, congestion control range information defined by using a data transmission mode that is used or prohibited, congestion control range information defined by using a multi-hop transmission configuration, congestion control range information defined by using a node type, and congestion control range information defined by using a node attribute. Actually, the congestion control range information may also be defined by using other means, and it is no longer described one by one here.

According to an embodiment of the present disclosure, in addition to determining the congestion range based on the received congestion related information, the network side node 200 further determines congestion control information and/or a congestion control strategy or congestion control strategies corresponding to a congestion control range or congestion control ranges based on the determined congestion control range or congestion control ranges, (Similarly, in the determining of the congestion control information and/or the congestion control strategy or congestion control strategies, the determining of the congestion control information and/or the congestion control strategy or congestion control strategies based on the congestion related information reported by the UE or UEs does not limit that the network side can determine the congestion control information and/or the congestion control strategy or congestion control strategies by only using the congestion related information reported by the UE or UEs, for example, the network side may also use the information obtained by other means (e.g., a server provides) and the congestion related information reported by the UE or UEs to collectively determine the congestion control information and/or the congestion control strategy or congestion control strategies), and transmits the determined congestion control information and/or the congestion control strategy or congestion control strategies corresponding to the congestion control range or congestion control ranges to the UE 300.

Herein, the congestion control information may include at least one of the congestion level information, the transmission rate optional range information, the transmission power optional range information, the priority information of the service/data permitted to be transmitted, the available resource pool information, the data transmission mode information that is permitted or prohibited, the multi-hop transmission configuration information. The congestion control strategy may include at least one of adjusting the transmission rate, adjusting the transmission power, adjusting the transmitted service, adjusting the size of the transmitted data packet, adjusting the number of occupied resources, adjusting the used resource pool, adjusting the data transmission mode, adjusting the multi-hop transmission configuration of the data transmission.

However, the congestion control information and the congestion control strategy are not limited to the above examples. In addition, either the congestion control information or the congestion control strategy may be indicated by using the practical physical value or be indicated by using the index information. Moreover, the congestion control strategy may also carry the corresponding adjustment value in order to allow the UE to use the adjusted value for the data transmission, for example, the adjustment value carried in the congestion control strategy may be an adjusted transmission rate value, an adjusted transmission power value, an adjusted value of transmitted service, an adjusted value of the size of transmitted data packet, an adjusted value of the number of occupied resources, an adjusted value of used resource pool, an adjusted data transmission mode, an adjusted multi-hop transmission configuration of the data transmission, but it is not limited thereto.

It also should be noted that the UE of reporting the congestion related information and the UE of receiving the congestion control range information, the congestion control information, and the congestion control strategy transmitted by the network side may not be the same UE. For example, since the UE A does not meet the report condition of the congestion related information, the congestion related information obtained by itself is not reported, but if the information such as the congestion control range information is transmitted in a broadcasting mode, the UE A may receive the congestion control information, and performs the corresponding congestion control when determining that it is within the corresponding congestion control range.

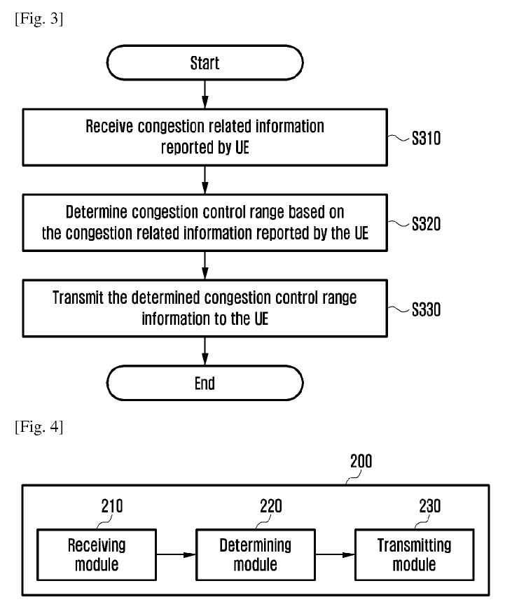

Next, the congestion control method for a network side node and the detailed configuration of the network side node will be described in detail with reference to FIG. 3 and FIG. 4.

FIG. 3 is a flowchart which illustrates a congestion control method for a network side node according to an exemplary embodiment of the present disclosure.

Referring to FIG. 3, at step S310, the network side node may receive the congestion related information reported by a UE or UEs, wherein, the congestion related information reported by the UE or UEs may include at least one of geographic location information of the UE or UEs, channel/resource occupation status information, RSSI measurement information, transmission power information of the UE or UEs, transmission rate information of the UE or UEs, transmission service information of the UE or UEs, information about the number of resources occupied by the UE or UEs, transmission service priority information of the UE or UEs, type information of a node or nodes corresponding to the UE or UEs, attribute information of the node or nodes corresponding to the UE or UEs, motion state information of the UE or UEs, road environment information perceived by the UE or UEs, and success rate information of the UE or UEs receiving a data packet or data packets transmitted by a surrounding node or surrounding nodes, but it is not limited thereto.

At step S320, a congestion control range or congestion control ranges may be determined based on the congestion related information reported by the UE or UEs. Specifically, the network side node may select a physical variable or physical variables for defining the congestion control range, and then determine a congestion control range or congestion control ranges based on at least one information included in the congestion related information reported by the UE or UEs according to the selected physical variable or physical variables for defining the congestion control range. According to an embodiment of the present disclosure, a physical variable or physical variables for defining the congestion control range or congestion control ranges may be selected in real time by the network side node or may be selected in accordance with a convention between the network side node and the UE, or may be indicated by a protocol specification or indicated by a high layer signalling, or configured by a high layer entity. For example, the physical variable for defining the congestion control range may include at least one of a geographic area, a resource pool, a power range, a transmission rate range, a priority of transmitted service/data, a data transmission mode that is used or prohibited, a multi-hop transmission configuration, a node type and a node attribute. However, it should be understood that a physical variable or physical variables of the present disclosure for defining the congestion control range is/are not limited to the above examples, but may include any physical variable that may limit the transmission behavior of the UE or UEs or a matter related to the transmission behavior of the UE or UEs.

For example, in a case that the selected physical variable for defining the congestion control range is the geographical area, a congestion control range or congestion control ranges may be determined based on the geographic location information of the UE or UEs reported by the UE or UEs, here, the congestion control range or congestion control ranges is/are defined by the geographical area. Specially, a distribution density of UEs may be determined based on the geographical location information of the UE or UEs reported by the UE or UEs, and the geographical areas for which a congestion control is required may be determined based on the distribution density of the UEs.

Alternatively, in a case that the selected physical variable for defining the congestion control range is the geographical area, a congestion control range or congestion control ranges may also be determined based on the geographical location information and the channel/resource occupation status information reported by the UE or UEs, here, the congestion control range is defined by the geographical area. Specially, based on the geographical location information of the UE or UEs and the channel/resource occupation status information in a corresponding resource pool used by the UE or UEs, reported by the UE or UEs, it may be determined which geographical areas require a congestion control through setting a geographic area in which channel/resource occupation status information are similar into one congestion control range. Alternatively, in a case that the selected physical variable for defining the congestion control range is the resource pool, the congestion control range may be determined based on the channel/resource occupation status information reported by the UE or UEs, here, the congestion control range is defined by the resource pool. Specially, it may be determined which resource pool or pools requires/require a congestion control based on the channel/resource occupation status information in the corresponding resource pool used by the UE or UEs, reported by the UE or UEs.

As another example, in a case that the selected physical variables for defining the congestion control range are both the geographical area and the resource pool, the congestion control range may be determined based on the geographic location information of the UE or UEs and the channel/resource occupation status information reported by the UE or UEs, in this case, the congestion control range is defined collectively by both the geographical area and the resource pool. Specially, a resource occupation status in each resource pool of each geographical area may be determined based on the geographic location information of the UE or UEs and the channel/resource occupation status information in the corresponding resource pool used by the UE or UEs, reported by the UE or UEs, and the congestion control range may be determined according to the resource occupation status. For example, the determined congestion control range may be the resource pool 1 and the geographical areas are 1 and 2, or the determined congestion control range may be the resource pool 2 and the geographical area is 3. It should be noted that the geographic area may be identified by coordinates able to define the corresponding area range, or be identified by the area center and the radius of the area, or be identified in the location area index mode or be identified in other ways.

Alternatively, in a case that the selected physical variables for defining the congestion control range are the geographical area, the used data transmission mode and the multi-hop transmission configuration, the congestion control range may be determined based on the geographic location information of the UE or UEs reported by the UE or UEs, the motion state information of the UE or UEs and the road environment information perceived by the UE or UEs. Specially, the distribution density of UEs may be determined based on the geographical location information reported by the UE or UEs, the driving speed may be determined based on the motion state information of the UE or UEs, the road condition may be determined based on the road environment information perceived by the UE or UEs, and further, the geographical area for which a congestion control is required, the used data transmission mode and the multi-hop transmission configuration of a UE or UEs for which a congestion control is required may be determined based on the three factors (the determined distribution density of the UEs, the driving speed and the road environment perceived by the UE or UEs), and the congestion control range is finally defined by the geographical area, the used data transmission mode and the multi-hop transmission configuration.

As another example, in a case that the selected physical variables for defining the congestion control range are the power range, the transmission rate range, the transmitted service priority, the node type and the node attribute, the congestion control range may be determined based on the transmission power information, the transmission rate information, the transmission service and its priority information, the node type information, and the node attribute information reported by the UE or UEs. Specially, the power (or the power range) used for transmitting data of the UE or UEs may be determined based on the transmission power information reported by the UE or UEs, and the transmission rate (or rate range) used by the transmission data of the UE or UEs is determined based on the transmission rate information reported by the UE or UEs, the service transmitted by the UE or UEs and the priority corresponding the service may be determined based on the transmission service and its priority information reported by the UE or UEs, the type of the node (such as ordinary vehicles, buses, fire engines, police cars, etc.) may be determined based on the node type information, the size of the node may be determined based on the node attribute information, and so on. Moreover, by the five factors, the transmission power range, the transmission rate range, the transmitted service and/or the priority corresponding to the service, the node type and the node attribute of the UE or UEs for which the congestion control range is required are defined, and the congestion control range may defined by the power range, the transmission rate range, the transmitted service priority, the node type and the node attribute.

It should be understood that in the present disclosure, the physical variables for defining the congestion control range are not limited to the above examples or the above combination.

In the case that the congestion control range is defined by using the geographical area (and other physical variables), the geographic area may be indicated by at least one of the following items:

absolute location information (such as coordinates) corresponding to the geographic area; for example, when the geographical area is a quadrilateral, the quadrilateral area may be indicated by the GNSS coordinates corresponding to the four vertices corresponding to the given quadrilateral; when the geographical area is a circular, the circular area may be indicated by the GNSS coordinates of the center of the given circular and the corresponding radius length.

relative location information (such as relative coordinates) corresponding to the geographic area; for example, a reference location (such as the center of the base station) is determined at first, and then the geographical area is indicated by the relative relationship between the geographic area and the reference location. For example, when the geographical area is a quadrilateral, the quadrilateral area may be indicated by the relative coordinate of the four corresponding vertices of the given quadrilateral and the reference location; when the geographical area is a circular, the circular area may be indicated by the relative coordinate of the center of the given circular and the reference location, as well as the corresponding radius length. The UE or UEs may determine the specific location of the geographic area based on the reference location (coordinate) and the relative coordinate.

index information corresponding to the geographic area; for example, when the geographical area to be indicated has been or may be divided into basic areas by using the specified specification (or may also be described by using other names, such as a subregion, a unit area, etc., it is not limited thereto), then the congestion control range may be indicated by using a mode of the basic area index. The basic area index may use a single-layer index or a multi-layer index, or may use a relative index or may also use an absolute index. Some examples are as follows:

a single-layer index: the corresponding geographical area for the congestion control may be located by one index value. As shown in FIG. 7, assuming that the coverage of one cell includes 36 following basic areas, and these areas are numbered uniformly. When the base station determines that the geographical area corresponding to one or some of the basic areas needs the congestion control, it only needs to transmit the index value of the corresponding area to the UE.

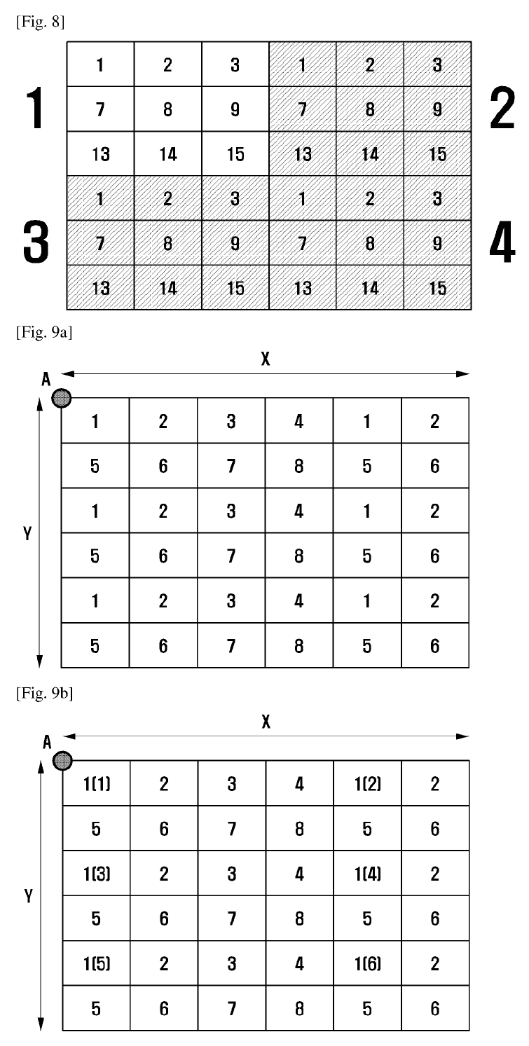

a multi-layer index: the corresponding geographical area for the congestion control is indicated by a plurality of index values. As shown in FIG. 8, assuming that the coverage of one cell includes 36 following basic areas, every nine basic areas may form one first-level area (different colors represent different first-level areas). When the base station determines that the geographical area corresponding to one or some of the basic areas needs congestion control, the index of the first-level area corresponding to the basic area is indicated, and then the relative index of the basic area in its first-level area is indicated, for example, [1, 8] may be used to represent the basic area in the first-level area 1 of which the relative index value is 8. It should be noted that in the example in which the multi-layer index is described here by the basic area and the first-level area, in the actual implementation, a multi-level area and a multi-layer index may be set according to the demand to indicate the geographical area corresponding to the congestion control.

an absolute index: when an area has an absolute (unique) index within a set range (such as a cell, a base station, a country, a region), the area may be indicated to the UE by the absolute (unique) index number corresponding to the area.

a relative index: when an area has only a relative indexing number (such as the example in the above multi-layer index), the area may be indicated to the UE by the relative index of the area and other information (such as the primary index described above) that may determine the absolute location of the area. Herein, another embodiment is given: a relative index+a internal number of the area index+absolute location information of the benchmark basic area setting location. As shown in FIG. 9a and FIG. 9b, assuming that there are a plurality of basic areas with the same index value (for example, there are 6 areas with an index value of 1). In order to uniquely indicate one basic area, it may be used in the following manner: firstly, internally numbering the basic area with the same index value according to the setting rule, such as, by using the principle of the horizontal direction firstly and then longitudinal direction, as shown in FIG. 9b, the internal numbers of the six areas with an index value of 1 are shown in ( ); Then determining the benchmark basic area, and giving the absolute indication information of the benchmark basic area location. The basic area shown in “1 (1)” in FIG. 9b is determined as the benchmark basic area and the GPS coordinate of the basic area vertex (the point A as shown in the figure) and the horizontal length (X) and the longitudinal length (Y) of the cell are indicated. The UE may uniquely determine the basic area location indicated by the network based on the absolute indication information of the benchmark basic area location, the basic area index value indicated by the network and the internal numbers of the basic areas with the same index value.

Furthermore, regardless of determining the absolute index or the relative index of the area, the base station needs to transmit the relevant configuration information for determining the index value of the area to the UE so that the UE may determine which area it is located in, for example, the length information and the width information of the area (including the “basic area”, “first-level area” and the areas with more levels that are added according to needs), the horizontal and vertical modulo information corresponding to the area index, and the like. Two specific examples in which the UE determines the area index based on the relevant configuration information for determining area, transmitted by the network, are as follows:

### Example 1: A Single-Layer Index

the relevant configuration information for determining the area transmitted by the network:

⋄ The length of the basic area (L): 20 m, the width of the basic aera (W): 20 m

⋄ the horizontal modulo value of the basic area index (Nx): 4, the vertical modulo value of the basic area index (Ny): 2

the UE calculates the area index according to the relevant configuration information for determining the area transmitted by the network:

⋄ x=Floor (x0/L) Mod Nx;

⋄ y=Floor (y0/W) Mod Ny;

the basic area index=y Nx+x.

Herein, x0 and y0 are the horizontal coordinate and the vertical coordinate of the UE (such as the coordinate determined based on the GPS), respectively. When Nx and Ny are 0, it is equivalent to no modulo operation.

### Example 2: A Multi-Layer Index

the relevant configuration information for determining the area transmitted by the network:

⋄ The length of the basic area (L): 20 m, the width of the basic aera (W): 20 m

⋄ the horizontal modulo value of the basic area index (Nx): 4, the vertical modulo value of the basic area index (Ny): 2

⋄ the length of the first-level area (L1): 80 m (herein, L1=L*Nx, or may be set by using other ways), and the width of the first-level area (W1): 40 m (herein, W1=W*Ny, or may be set by using other ways)

⋄ the horizontal modulo value of the first-level area index (Nx1): 8, the vertical modulo value of the first-level area index (Ny1): 1

the UE calculates the area index according to the relevant configuration information for determining the area transmitted by the network:

⋄ x=Floor (x0/L) Mod Nx;

⋄ y=Floor (y0/W) Mod Ny;

⋄ x1=Floor (x0/L1) Mod Nx1;

⋄ y1=Floor (y0/W1) Mod Ny1;

⋄ the first-level area index=y1*Nx1+x1.

⋄ the relative index corresponding to the basic area in the first-level area=y Nx+x.

### Example 3: A Relative Index (a Relative Index+a Internal Number of the Area Index+Absolute Location Information of a Benchmark Basic Area Setting Location)

the relevant configuration information for determining the area transmitted by the network:

⋄ the horizontal coordinate of the vertex of the basic area: Xr

⋄ the vertical coordinate of the vertex of the basic area: Yr

the UE calculates the area index and the internal number of the area index according to the relevant configuration information for determining the area transmitted by the network:

⋄ x=Floor ((x0−Xr)/L) Mod Nx;

⋄ y=Floor ((y0−Yr)/W) Mod Ny;

⋄ Sx=Floor (Floor ((x0−Xr)/L)/Nx);

⋄ Sy=Floor(Floor ((y0−Yr)/W)/Ny);

⋄ Sx_max=(x<=Floor ((X)/L) Mod Nx))?(Floor (Floor (X)/L)/Nx)+1: Floor (Floor ((X)/L)/Nx))

basic area index=y Nx+x;

the internal number of the area index=Sy*Sx_max+Sx.

In addition, in addition to determining the congestion control range or congestion control ranges, the congestion control information and/or a congestion control strategy or congestion control strategies corresponding to a congestion control range or congestion control ranges may be further determined based on the determined congestion control range or congestion control ranges. For example, the congestion control information and/or the congestion control strategy or congestion control strategies may be determined based on congestion features in the determined congestion control range or congestion control ranges.

For example, assuming that the UE is a vehicle UE and the physical variables for defining the congestion control range are both the geographical area and the resource pool (i.e., the congestion control range is collectively defined by both the geographic area and the resource pool), if the congestion control range has been determined based on the congestion related information reported by the UE or UEs, and it is assumed that the congestion features in the determined congestion control range are as follows: 1) the vehicle density within the determined congestion control range has been greater than the set vehicle density threshold; 2) the resource pool used by the vehicle UE is X, 3) there is no channel occupation rate CBR (channel busy ratio), transmission power, transmission rate and other information of each vehicle, then the congestion control information may be determined based on the congestion features of the above determined congestion control range as: defining the transmission power range and the transmission rate range information permitted to be used by the UE within the congestion control range (herein, it is assumed that the congestion control range is collectively defined by both the geographical area and the resource pool). At this time, the specific congestion control strategy may not be determined, while the corresponding congestion control strategy is determined by the UE according to the congestion control information. Alternatively, assuming that the selected physical variable for defining the congestion control range is a resource pool, according to the determined resource pool for which congestion control is required, the transmission power range and the transmission rate range permitted to be used by the UE within the resource pool for which congestion control is required may be further defined through the congestion control information, and meanwhile, the congestion control strategy is formulated to prohibit the data transmission of the service type 2 and the service type 3.

Alternatively, assuming that the determined congestion control features of the corresponding congestion control range are: 1) the network side node may obtain the channel/resource occupation status information of the corresponding resource pool reported by the UE; 2) the service information transmitted by the UE; 3) but the location information of the UE may not be obtained in real time, then the congestion control strategy may be determined based on the above features as: 1) increasing the number of resources in the resource pool corresponding to the determined congestion control range; 2) reducing the types of services able to be transmitted in the resource pool.

Alternatively, for example, if the UE transmits the V2X data with priority of 1, 2 and 3 by using the resource in resource pool 1, the network side may indicate the congestion control information and the congestion control strategy or congestion control strategies corresponding to the resource pool 1. For example, the congestion control information is: the transmission power range: 12 dBm-15 dBm, the transmission rate range: 500 ms-1000 ms (data packet transmission cycle), the corresponding priority is 2. For example, the congestion control strategy is: to prohibit the transmission of the data with the priority greater than 2. Assuming that the UE determines that the resource pool 1 used by itself is within the congestion control range after the UE receives the congestion control range information, the UE may perform the congestion control according to the received congestion control information and the congestion control strategy. The congestion control performed by the UE are as follows: 1) canceling the transmission of the V2X data with priority of 3; 2) the transmission power of the V2X data with priority of 2 is limited within the range of 12 dBm-15 dBm, the transmission rate (data packet transmission cycle) is limited within the range of 500 ms-1000 ms, and the specific transmission power value and the transmission rate value may be determined by the specific congestion algorithm used by the UE; 3) the congestion control may not be performed for the transmission of the V2X data with priority of 1.

Alternatively, the congestion control information and/or a congestion control strategy or congestion control strategies corresponding to a congestion control range or congestion control ranges may be indicated by one or more of the following modes:

1) a configuration parameter table or configuration parameter tables corresponding to the congestion control range or congestion control ranges (such as a table of the relationship between the constant bit rate CBR (range) value corresponding to the different PPPP (ProSe Per-Packet Priority) and the corresponding transmission parameter (set)). An example is shown in Table 1 below. Assuming that the CBR range index is 0-15, the PPPP index is 0-3, and the transmission parameter (set) index is 1-60. After the UE receives the table, the UE may determine the corresponding CBR range index according to the measured CBR value by itself at first and then determine the corresponding transmission parameter set index according to the CBR range index and the PPPP index corresponding to the transmission parameter (set). The corresponding transmission parameter set is determined according to the transmission parameter set index, and the transmission parameter used in the transmission of data of the UE may be ultimately determined.

TABLE 1

| | | transmission |
|---|---|---|
| CBR range index | PPPP index | parameter set index |
| 0 | 0 | 1 |
| 0 | 1 | 2 |
| 0 | 2 | 3 |
| 0 | 3 | 4 |
| 1 | 0 | 5 |
| 1 | 1 | 6 |
| 1 | 2 | 7 |
| 1 | 3 | 8 |
| . . . | . . . | . . . |
| 15 | 0 | 57 |
| 15 | 1 | 58 |
| 15 | 2 | 59 |
| 15 | 3 | 60 |

2) One or more offset values corresponding to the congestion control range or congestion control ranges. The offset value is used to indicate the offset relationship between the parameter values or the parameter indexes based on the specific configuration parameter table or configuration parameter tables to identify the correspondence between the parameter values or the parameter indexes in the configuration parameter table corresponding to each congestion control range, or is used to indicate the UE or UEs to determine the CBR range (index) or the CBR index, in particular,

such as, the offset value (offset1) used to indicate the correspondence between the PPPP index value (and/CBR (range) (index) value) corresponding to each congestion control range and the transmission parameter set index, or the offset value (offset2) used to indicate the UE or UEs within each congestion control range to determine the CBR range or the CBR index. The specific configuration parameter table (herein, the configuration parameter table may also use other names, such as lookup table, query table, etc.) may be configured based on the cell, the area (such as zone, region, etc.) with the same ID, the resource pool or other range definitions. The offset value may be configured based on a geographic area, a single UE, or a UE that meets the particular requirement, or other range definitions.

If the offset value is offset1, the offset value is used to give the offset1 value of the corresponding transmission parameters (set), the CBR (range) value (index) and the PPPP (range) value (index) for the different congestion control ranges, different transmission resource pools, different UEs or the whole cell, based on the correspondence between the parameters in the basic configuration parameter table or configuration parameter tables (for example, the above table that provides the relationship between the PPPP index value, the CBR (range) value (index) and the corresponding transmission parameter (set) (index) is used as the basic configuration parameter table).

Assuming that the relationship of the PPPP, the CBR (range) value (index) and the corresponding transmission parameter (set) (index) in the basic configuration parameter table is shown in Table 1. Assuming that the offset1 value corresponding to a certain congestion control range is 2, then after the transmission parameter (set) (index) has been moved up two rows, the correspondence between the transmission parameter (set) (index) and the PPPP, the CBR (range) value (index) is shown in Table 2.

TABLE 2

| | | Transmission |
|---|---|---|
| CBR range index | PPPP index | parameter set index |
| 0 | 0 | 3 |
| 0 | 1 | 4 |
| 0 | 2 | 5 |
| 0 | 3 | 6 |
| 1 | 0 | 7 |
| 1 | 1 | 8 |
| 1 | 2 | 9 |
| 1 | 3 | 10 |
| . . . | . . . | . . . |
| 15 | 0 | 59 |
| 15 | 1 | 60 |
| 15 | 2 | 60 (or N/A) |
| 15 | 3 | 60 (or N/A) |

If the offset value is offset2, the offset value is used to determine the CBR range (index) used when mapping to the transmission parameter set index based on the CBR measured by the UE. The offset2 may be configured according to the cell range, the congestion control range or category, or the resource pool, or the individual offset2 can be configured for the UE. The UE receives the broadcast signalling or unicast signalling of the eNB to obtain the offset2 value. At this time, the CBR range (index) CBRI value used by the UE to map to the transmission parameter set index is determined according to CBRI=CBRm+offset2, wherein CBRm is the CBR range (index) determined according to the CBR obtained by the UE through the measurement. For example, based on the above Table 1, assuming that the CBRm obtained by a certain UE through the measurement is 0, the PPPP is 0 and the offset2 is 1, the transmission parameter set that the UE should use is the transmission parameter set 7 corresponding to the CBR range index 1 and PPPP index 0.

It should be noted that the configuration parameter table or configuration parameter tables described in the present disclosure is merely a description method of the relationship between the parameters in the configuration parameter set, and also, the relationship may be described by using other methods, such as a configuration parameter set, a configuration parameter combination, and the like.

It should be understood that the above congestion control information and the congestion control strategy are merely examples. According to an exemplary embodiment of the present disclosure, the congestion control information may include at least one of the congestion level information, the transmission rate optional range information, the transmission power optional range information, the priority information of service/data permitted to be transmitted, the available resource pool information, the data transmission mode information that is permitted or prohibited, the multi-hop transmission configuration information, however, the congestion control information of the present disclosure is not limited thereto, and may include any information for controlling matters related to the transmission behavior. In addition, according to an exemplary embodiment of the present disclosure, the congestion control strategy may include at least one of adjusting the transmission rate, adjusting the transmission power, adjusting the transmitted service, adjusting the size of transmitted data packet, adjusting the number of occupied resources, adjusting the used resource pool, adjusting the data transmission mode, adjusting the multi-hop transmission configuration of the data transmission, however, the congestion control strategy of the present disclosure is not limited thereto, and may include any strategy for adjusting the transmission behavior.

At step S330, the determined congestion control range information is transmitted to a UE or UEs. Herein, the congestion control range information includes at least one of congestion control range information defined by using the geographical area, congestion control range information defined by using a resource pool, congestion control range information defined by using a power range, congestion control range information defined by using a transmission rate range, congestion control range information defined by using a priority of transmitted service/data, congestion control range information defined by using a data transmission mode that is used or prohibited, congestion control range information defined by using a multi-hop transmission configuration, congestion control range information defined by using a node type, and congestion control range information defined by using a node attribute. It should be understood that the corresponding congestion control range information will be different depending on the selected physical variable or physical variables for defining the congestion control range.

If the congestion control information and/or the congestion control strategy or congestion control strategies are further determined based on the determined congestion control range or congestion control ranges at step S320, the determined congestion control information and/or the congestion control strategy and congestion control strategies may also be transmitted to the UE or UEs at step S330. Specifically, for example, the IE related to “congestion control” may be added in the SIB X and/or the RRC connection reconfiguration message corresponding to the V2X and/or in the mobility Control Info IE in the RRC connection reconfiguration message, so that the determined congestion control range information, the determined congestion control information and/or the congestion control strategy or congestion control strategies are transmitted to the UE or UEs. The newly added IE may include two parts (two parts may be designed as two independent IEs): 1) the congestion control range information; 2) the congestion control information and/or a congestion control strategy or congestion control strategies information corresponding to a congestion control range or congestion control ranges. Of course, the congestion control information and the congestion control strategy or congestion control strategies may also be indicated by using independent IEs, respectively. Further, each item of the congestion control range information, each item of the congestion control information, and each item of the congestion control strategy may also be indicated by independent IEs, respectively.

It should be noted that the above SIB X and RRC connection reconfiguration message are merely two specific ways of transmitting the congestion control range information, the determined congestion control information and/or the congestion control strategy or congestion control strategies using a broadcast mode and/or a dedicated signalling mode. In the concrete implementation, other broadcast messages and/or dedicated signalling may be used for the transmission. In addition, it should be noted that when the information related to the congestion control (including the congestion control range information, the determined congestion control information and/or the congestion control strategy or congestion control strategies) is transmitted by using the dedicated signalling, since the UE receiving the dedicated signalling is clear, the congestion control range information may not be carried in the information related to the congestion control transmitted at this time. That is, The UE merely needs to perform the congestion control according to the congestion control information and/or the congestion control strategy or congestion control strategies, without determining whether it is within the congestion control range based on the congestion control range information. That is, in the case where the congestion control information and/or the congestion control strategy or congestion control strategies of the UE are notified by using the dedicated signalling, the congestion control method described in the present disclosure may also be described in the following manners:

receiving a congestion related information reported by a user equipment UE or UEs;

determining a UE or UEs for which the congestion control is required based on the congestion related information reported by a UE or UEs;

transmitting corresponding congestion control information and/or a congestion control strategy or congestion control strategies to the determined UE or UEs for which the congestion control is required.

The content of the congestion control information and/or the congestion control strategy or congestion control strategies transmitted to the UE or UEs using the dedicated signalling may be the same as the congestion control information and/or the congestion control strategy or congestion control strategies corresponding to a congestion control range or congestion control ranges that are described in the above description. That is, the difference between them is only that the congestion control information and/or the congestion control strategy or congestion control strategies corresponding to a congestion control range or congestion control ranges described above are used to indicate that all the UEs within the congestion control range perform the transmission parameter adjustment. Herein, the congestion control information and/or the congestion control strategy or congestion control strategies transmitted by using the dedicated signalling are used only to indicate that the corresponding UE or UEs performs the transmission parameter adjustment. Therefore, the content of the congestion control information and/or the congestion control strategy or congestion control strategies carried in the dedicated signalling and the manner of carrying the congestion control information and/or the congestion control strategy or congestion control strategies in the dedicated signalling are not described repeatedly.

The congestion control information and/or the congestion control strategy or congestion control strategies transmitted by using the dedicated signalling may only be transmitted to a UE or UEs in the connected state, however, there may be a UE in a idle state in the congestion range. In order that all UEs within the congestion control range can obtain new congestion control information and/or a new congestion control strategy or new congestion control strategies when the congestion control is performed, the network side may notify the UE or UEs to access the network so as to update its congestion control information and/or its congestion control strategy or congestion control strategies in the following manner:

receiving a congestion related information reported by a user equipment UE or UEs;

determining a congestion control range or congestion control ranges based on the congestion related information reported by the UE or UEs;

transmitting the paging message by network side, wherein the paging message carries the information about the congestion control range or congestion control ranges;

the processing of the UE side is as follows:

determining whether the UE is within the congestion control range or congestion control ranges, after receiving the paging message transmitted by the network;

accessing to the network when determining that the UE is within the congestion control range or congestion control ranges;

transmitting, by the network side, the corresponding congestion control information and/or the congestion control strategy or congestion control strategies to the UE or UEs by using the dedicated signalling after the UE or UEs accesses to the network.

In addition, alternatively, a dedicated SIB may be set for the congestion control of the V2X. The current 36.331 has defined a new SIB and a related IE for sidelink communication of the V2X. Based on the current state, the following two ways may be used to add the congestion control related information: 1, adding the congestion control information in SL-CommResourcePool-r14; 2, adding a new IE under SLV2X-ConfigCommon-r14 (corresponding to the SIB) and/or v2x-Comm TxPoolNormalDedicated-r14 (corresponding to the RRC connection reconfiguration message) and/or MobilityControlInfoV2X-r14 (corresponding to the handover process). Alternatively, it also may add the specific MBMS service type, and notify the UE of the congestion control information, the congestion control information and/or the congestion control strategy through the specialized MBMS service. Herein, since the congestion situation of V2X is constantly changing, the network side may update the transmitted congestion control related information (including one or more of the congestion control range information, the congestion control information and the congestion control strategy or congestion control strategies). The update method may use the periodic update mode, and may also use the event-triggered update mode. In addition, the network side may further notify the UE or UEs to perform updating via paging or MCCH when the content of the transmitted congestion related information is changed.

FIG. 4 is a block diagram which illustrates the configuration of the apparatus for congestion control according to exemplary embodiment. Reference to FIG. 4, the apparatus 200 (or the network side node 200) for congestion control at the network side may include a receiving module 210, a determining module 220, and a transmitting module 230. However, the present disclosure is not limited thereto, and the network side node 200 may also include, according to the actual requirements, other modules, such as a storage module or a congestion control related information update module (not shown). According to an exemplary embodiment of the present disclosure, the receiving module 210 may receive the congestion related information reported by a user equipment UE or UEs. The congestion related information has been described above with reference to FIG. 3, and it will not be described repeatedly here. The determining module 220 may determine the congestion control range or congestion control ranges based on the congestion related information reported by a UE or UEs. In particular, the determining module 220 may select a physical variable or physical variables for defining the congestion control range or congestion control ranges and determine the congestion control range or congestion control ranges based on at least one information included in the congestion related information reported by the UE or UEs according to the selected physical variable or physical variables for defining the congestion control range, here, the physical variable or physical variables for defining the congestion control range is/are selected in real time by the network side node or is/are selected in accordance with a convention between the network side node and the UE, or is/are indicated by a protocol specification or is/are indicated by a high layer signalling, or is configured by a high layer entity. The physical variable for defining the congestion control range has been described above with reference to FIG. 3, and thus will not be described repeatedly. As an example, if the selected physical variable for defining the congestion control range is the geographic area, the determining module 220 may determine the congestion control range based on the geographic location information of the UE or UEs reported by the UE or UEs, here, the congestion control range is defined by the geographic area. In particular, the determining module may determine the distribution density of UEs based on the geographic location information of the UE or UEs reported by the UE or UEs and determine which geographic area or areas requires/require a congestion control based on the distribution density of the UEs. Alternatively, if the selected physical variable for defining the congestion control range is the geographic area, the determining module 220 may also determine the congestion control range based on the geographic location information and the channel/resource occupation status information reported by the UE or UEs, here, the congestion control range is defined by the geographic area. Specially, based on the geographical location information of the UE and the channel/resource occupation status information in a corresponding resource pool used by the UE or UEs, reported by the UE or UEs, the determining module 220 may determine which geographical area or areas requires/require a congestion control through setting a geographic area in which channel/resource occupation status information are similar into one congestion control range. Alternatively, if the selected physical variable for defining the congestion control range is the resource pool, the determining module 220 may determine the congestion control range based on the channel/resource occupation status information reported by the UE or UEs, here, the congestion control range is defined by the resource pool. Specially, the determining module 220 may determine which resource pool or pools requires/require a congestion control based on the channel/resource occupation status information in the corresponding resource pool used by the UE or UEs reported by the UE or UEs. As another example, if the selected physical variables for defining the congestion control range are both the geographical area and the resource pool, the determining module 220 may determine the congestion control range based on the geographic location information of the UE or UEs and the channel/resource occupation status information reported by the UE or UEs, wherein the congestion control range is defined collectively by both the geographical area and the resource pool. Specially, the determining module 220 may determine the resource occupation status in each resource pool of each geographical area based on the geographic location information of the UE or UEs and the channel/resource occupation status information in the corresponding resource pool used by the UE, reported by the UE or UEs, and determine the congestion control range according to the resource occupation status. After the determining module 220 determines the congestion control range or congestion control ranges, the transmitting module 230 may transmit the congestion control range information to the UE.

According to an exemplary embodiment of the present disclosure, the determining module 220 may further determine the congestion control information and/or the congestion control strategy or congestion control strategies corresponding to a congestion control range or congestion control ranges based on the determined congestion control range or congestion control ranges, in addition to determining the congestion control range based on the congestion related information reported by the UE or UEs. In this case, the transmitting module 230 may transmit the congestion control information and/or the congestion control strategy or congestion control strategies corresponding to the congestion control range information to a UE or UEs, in addition to transmitting the determined congestion control range information to the UE or UEs.

In addition, since the congestion situation of V2X is constantly changing, the network side may include an updating module to update the congestion control related information (including one or more of the congestion range control information, the congestion control information and the congestion control strategy or congestion control strategies). The update method may use the periodic update mode, and may also use the event-triggered update mode. In addition, the network side may further notify the UE to perform updating via paging or MCCH when the content of the transmitted congestion related information is changed.

The congestion control range information, the congestion control information and the congestion control strategy have been described in detail with reference to FIG. 3, and thus will not be described repeatedly here.

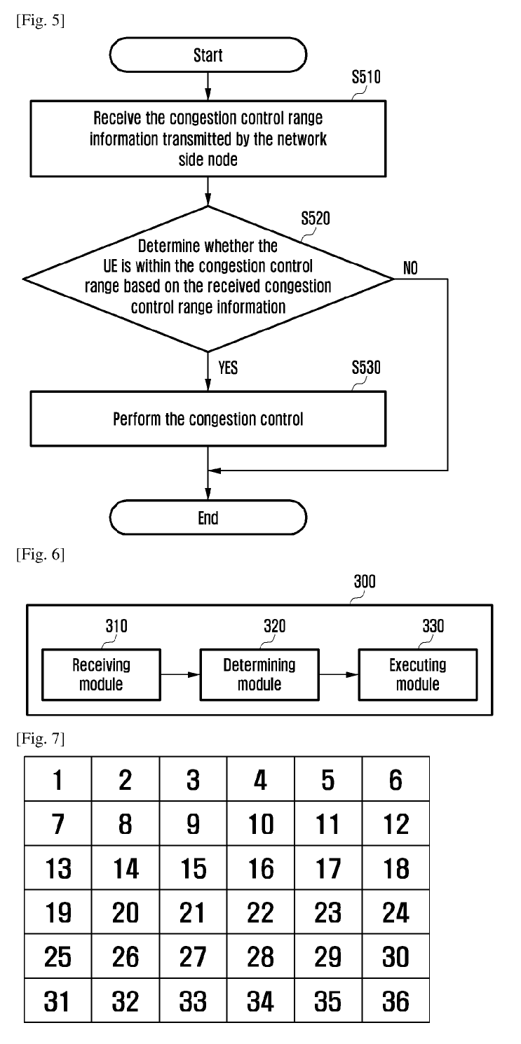

FIG. 5 is a flowchart which illustrates a congestion control method for a user equipment (UE) according to exemplary embodiment of the present disclosure. firstly, at step S510, the UE may receive the transmitted congestion control range information from the network side node, here, the congestion range information may include at least one of congestion control range information defined by using the geographical area, congestion control range information defined by using a resource pool, congestion control range information defined by using a power range, congestion control range information defined by using a transmission rate range, congestion control range information defined by using a priority of transmitted service/data, congestion control range information defined by using a data transmission mode that is used or prohibited, congestion control range information defined by using a multi-hop transmission configuration, congestion control range information defined by using a node type, and congestion control range information defined by using a node attribute.

Next, at step S520, the UE may determine whether the UE is within the congestion control range based on the congestion control range information. If it is determined that the UE is within the congestion control range, the method may proceed to step S530 to perform the congestion control, and if it is determined that the UE is not within the congestion control range, the method may end. Herein, according to the congestion control range information received from the network side node, the UE may be within one or more congestion control ranges at the same time. For example, if a geographical area is used to define the congestion control range, the UE may determine the congestion control is required to be performed according to the congestion control range information received from the network side node when entering into the geographic area belonging to the congestion control range and then perform the congestion control. Herein, the UE may perform the congestion control in various ways. For example, the UE may perform the congestion adjustment (e.g., the transmission rate adjustment, the transmission power adjustment, the transmission service type adjustment, the adjustment of the priority corresponding to the service data, etc.) according to the congestion control algorithm preset in the UE, or preferably further perform the congestion control based on the congestion control information and/or the congestion control strategy or congestion control strategies received from the network side node, which will be described in detail below.

According to an embodiment of the present disclosure, in addition to receiving the congestion control range information transmitted by the network side node, the UE may also receive the congestion control information and/or the congestion control strategy or congestion control strategies corresponding to a congestion control range or congestion control ranges transmitted by the network side node. In this case, the performing of congestion control may include performing the congestion control based on the congestion control information and/or the congestion control strategy or congestion control strategies corresponding to a congestion control range or congestion control ranges.

In particular, the congestion control information may include at least one of: the congestion level information, the transmission rate optional range information, the transmission power optional range information, the priority information of service/data permitted to be transmitted, the available resource pool information, the data transmission mode information that is permitted or prohibited, the multi-hop transmission configuration information. The congestion control strategy may include at least one of: adjusting the transmission rate, adjusting the transmission power, adjusting the transmitted service, adjusting the size of transmitted data packet, adjusting the number of occupied resources, adjusting the used resource pool, adjusting the data transmission mode, adjusting the multi-hop transmission configuration of the data transmission.

The processing of the congestion control based on the congestion control information corresponding to the congestion control range may include, for example, when the UE is within the congestion control range, according to at least one of the received congestion control information corresponding to the congestion control range, the UE may adjust at least one of the transmission power, the transmission rate, the transmitted service, the size of the transmitted data packet, the number of occupied resources, the used resource pool, the available data transmission mode, the multi-hop transmission configuration of the data transmission according to the set congestion control algorithm. For example, if the congestion control information indicates that the transmission power range is between 12 dBm and 15 dBm and the transmission rate range is 500 ms to 1000 ms (the transmission period of the data packet), the UE may adjust the transmission power range to 12 dBm to 15 dBm, and adjust the transmission rate range to 500 ms to 1000 ms, the specific transmission power value and the transmission rate value may be determined by the specific congestion algorithm adopted by the UE.

The performing of congestion control based on the congestion control strategy or congestion control strategies corresponding to a congestion control range or congestion control ranges may include: according to at least one of the received congestion control strategy, the UE may adjust at least one of the transmission power, the transmission rate, the transmitted service, the size of the transmitted data packet, the number of occupied resources, the used resource pool, the available data transmission mode, the multi-hop transmission configuration of the data transmission according to the set congestion control algorithm. For example, if the congestion control strategy information indicates that the transmission power and the type of the transmission service need to be adjusted, the UE may adjust the transmission power and the transmission service by itself in a predetermined manner. For example, the transmission power may be adjusted according to the own congestion control algorithm of the UE, and certain transmission services may be defined according to the user's default settings.

In addition, according to the received congestion control strategy or congestion control strategies and the congestion control information, the UE may jointly determine at least one of the transmission power, the transmission rate, the transmitted service, the size of transmitted data packet, the number of occupied resources, the used resource pool, the available data transmission mode, the multi-hop transmission configuration of the data transmission according to the set congestion control algorithm. For example, if the congestion control information indicates that the transmission power range is 12 dBm-15 dBm, the transmission rate range is 500 ms-1000 ms, and the range for the priority is 2, and the congestion control strategy is prohibiting the transmission of data with the priority greater than 2, the UE may stop transmitting the data packet with the priority of 3, and limit the power range corresponding to the data packet with the priority of 2 to 12 dBm-15 dBm and limit the transmission rate range to 500 ms-1000 ms.

FIG. 6 is a block diagram which illustrates the configuration of the apparatus for congestion control according to an exemplary embodiment of the present disclosure. As shown in FIG. 6, the apparatus 300 includes a receiving module 310, a determining module 320, and an executing module 330.

The receiving module 310 is used to receive the congestion control range information transmitted by the network side node. The determining module 320 is used to determine whether the apparatus is within the congestion control range based on the received congestion control range information. The executing module 330 is used to perform the congestion control in the case of determining that the apparatus is within a congestion control range or congestion control ranges.

When determining the UE is currently being within the congestion control range according to the congestion control range information received by the receiving module 310, the determining module 320 notifies the executing module 330 to perform the congestion control.

Herein, in addition to receiving the congestion control range information transmitted by the network side node, the receiving module 310 may also receive the congestion control information and/or the congestion control strategy or congestion control strategies corresponding to a congestion control range or congestion control ranges transmitted by the network side node. In this case, the executing module 330 may perform the congestion control based on the congestion control information and/or the congestion control strategy or congestion control strategies corresponding to a congestion control range or congestion control ranges.

The detailed process of performing congestion control based on the congestion control information and/or the congestion control strategy or congestion control strategies corresponding to a congestion control range or congestion control ranges has been described in detail with reference to FIG. 5, and will not be described repeatedly.

As described above, according to an exemplary embodiment of the present disclosure, through the UE reporting the congestion related information to the network side, the network side may more accurately grasp the global congestion situation, thus facilitating the formulation of more optimized congestion control strategy Meanwhile, this can reduce information exchange between the UEs, reduce the resource consumption of PC5 interface, and reduce the possibility of the occurrence of the congestion.

It should be noted that the congestion control range in the present disclosure may be described by other terms such as a transmission configuration adjustment range, a transmission parameter adjustment range, and the like. As long as the delineation of the range is related to the adjustment of the congestion, they may fall within the scope of the present disclosure.

The method according to the present disclosure may be recorded in a computer-readable medium including program instructions that perform various operations implemented by a computer. Examples of the computer-readable media include a magnetic media (e.g., a hard disk, a floppy disk and a tape); an optical media (e.g., a CD-ROM and a DVD); a magneto-optical media (e.g., a optical disk); and a specially configured hardware device for storing and executing program instructions (e.g., a read only memory (ROM), a random access memory (RAM), a flash memory, etc.). Examples of the program instructions include, for example, a machine code generated by the compiler and a file containing a high-level code that may be executed by a computer using an interpreter.

In addition, the various modules in the control apparatus according to the exemplary embodiment of the present disclosure may be implemented as hardware components or software components and may be combined according to the need. In addition, each module may be implemented by those skilled in the art using, for example, a field programmable gate array (FPGA) or an application specific integrated circuit (ASIC) according to the processing performed by the various defined modules.

While the present disclosure has been shown and described with reference to certain exemplary embodiments thereof, it will be understood by those skilled in the art that various changes in form and details may be made therein without departing from the spirit and scope of the disclosure as defined by the appended claims.

1. A method by a network node in a wireless communication system, the method comprising:
receiving a measurement report from a terminal performing a V2X communication;
determining congestion control information associated with a configuration parameter for the V2X communication based on the measurement report; and
transmitting a message including the congestion control information to the terminal.

2. The method of claim 1, wherein the message is an RRCconnectionReconfiguration message.

3. The method of claim 1, wherein the configuration parameter comprises a channel busy ratio (CBR), a ProSe Per-Packet Priority (PPPP) and a transmission parameter of the terminal.

4. The method of claim 3, wherein the congestion control information includes configuration list information indicates transmission parameters mapped corresponding to ranges of the CBR and PPPPs.

5. A method by a terminal in a wireless communication system, the method comprising:
transmitting a measurement report for performing a V2X communication to a network node; and
receiving a message including congestion control information associated with a configuration parameter for the V2X communication from the network node,
wherein the congestion control information is determined based on the measurement report by the network node.

6. The method of claim 5, wherein the message is an RRCconnectionReconfiguration message.

7. The method of claim 5, wherein the configuration parameter comprises a channel busy ratio (CBR), a ProSe Per-Packet Priority (PPPP) and a transmission parameter of the terminal.

8. The method of claim 7, wherein the congestion control information includes configuration list information indicates transmission parameters mapped corresponding to ranges of the CBR and PPPPs.

9. A network node in a wireless communication system, comprising:
a transceiver configured to receive a measurement report from a terminal performing a V2X communication; and
a controller configured to determine congestion control information associated with a configuration parameter for the V2X communication based on the measurement report, and control the transceiver to transmit a message including the congestion control information to the terminal.

10. The network node of claim 9, wherein the message is an RRCconnectionReconfiguration message.

11. The network node of claim 9, wherein the configuration parameter comprises a channel busy ratio (CBR), a ProSe Per-Packet Priority (PPPP) and a transmission parameter of the terminal.

12. The network node of claim 11, wherein the congestion control information includes configuration list information indicates transmission parameters mapped corresponding to ranges of the CBR and PPPPs.

13. A terminal in a wireless communication system, comprising:
a transceiver configured to transmit a measurement report for performing a V2X communication to a network node; and
a controller configured to control the transceiver to receive a message including congestion control information associated with a configuration parameter for the V2X communication from the network node,
wherein the congestion control information is determined based on the measurement report by the network node.

14. The terminal of claim 13, wherein the message is an RRCconnectionReconfiguration message.

15. The terminal of claim 13,
wherein the configuration parameter comprises a channel busy ratio (CBR), a ProSe Per-Packet Priority (PPPP) and a transmission parameter of the terminal, and.
wherein the congestion control information includes configuration list information indicates transmission parameters mapped corresponding to ranges of the CBR and PPPPs.
